(19) United States
(12) Patent Application Publication
(10) Pub. No.: US 2013/0170209 A1
(43) Pub. Date: Jul. 4, 2013

(54) OPTICAL SEMICONDUCTOR LIGHTING APPARATUS

(71) Applicants: Deok Ju LEE, Seongnam-si (KR); Yun Ha KIM, Seongnam-si (KR); Jung Hwa KIM, Seongnam-si (KR); Tae Hoon SONG, Seongnam-si (KR); Min A. JEONG, Seongnam-si (KR); Min Uk YOO, Seongnam-si (KR); Dae Won KIM, Seongnam-si (KR); Jae Young CHOI, Seongnam-si (KR); Haeng Ryeol LEE, Seongnam-si (KR)

(72) Inventors: Deok Ju LEE, Seongnam-si (KR); Yun Ha KIM, Seongnam-si (KR); Jung Hwa KIM, Seongnam-si (KR); Tae Hoon SONG, Seongnam-si (KR); Min A. JEONG, Seongnam-si (KR); Min Uk YOO, Seongnam-si (KR); Dae Won KIM, Seongnam-si (KR); Jae Young CHOI, Seongnam-si (KR); Haeng Ryeol LEE, Seongnam-si (KR)

(73) Assignee: POSCO LED COMPANY LTD., Seongnam-si (KR)

(21) Appl. No.: 13/601,277

(22) Filed: Aug. 31, 2012

(30) Foreign Application Priority Data
Dec. 29, 2011 (KR) 10-2011-0145346
Aug. 16, 2012 (KR) 10-2012-0089367

(51) Int. Cl. F21V 21/00

(52) U.S. Cl. 362/249.01

(57) ABSTRACT

An optical semiconductor lighting apparatus having at least one or more clamping units are formed along a longitudinal direction of a race way. A first sealing unit finishes both ends of a housing attached to or detached from the clamping unit. A second sealing unit surrounds upper and lower portions of both edges of an optical member disposed on the bottom surface of the housing. A wireless communication unit receives a dimming signal through a wireless communication network, and outputs the received dimming signal to a power supply unit. The power supply unit supplies a DC voltage to the light emitting module to control the illuminance of the light emitting module according to the dimming signal input from the wireless communication unit.

### CROSS-REFERENCE(S) TO RELATED APPLICATION

This application claims priority of Korean Patent Application No. 10-2011-0145346, filed on Dec. 29, 2011, and Korean Patent Application No. 10-2012-0089367, filed on Aug. 16, 2012, in the Korean Intellectual Property Office, both of which are hereby incorporated by reference in its entirety.

### BACKGROUND OF THE INVENTION

1. Field

The present invention relates to an optical semiconductor lighting apparatus.

2. Discussion of the Background

Compared with incandescent light and fluorescent light, optical semiconductors, such as LEDs or LDs, consume low power, have a long lifespan, and have high durability and high brightness. Due to these advantages, optical semiconductors have recently attracted much attention as one of components for lighting.

Facilities, such as underground parking lots, need to be equipped with lighting apparatuses having illuminance higher than that defined in Attached Table 1 of “Regulation for Standard of Evacuation/Fire Prevention Structure of Building”. Lighting apparatuses based on the above-described optical semiconductors (hereinafter, referred to as semiconductor lighting) are increasingly installed in buildings.

Also, these semiconductor lighting needs to maintain airtight seal to prevent penetration of water, such that the semiconductor lighting can satisfy IP grade with respect to lighting apparatuses (grade satisfying waterproofing and dustproofing) according to installation places, such as underground parking lots, or surroundings.

Meanwhile, various efforts have recently been made to save energy all over the world. As part of these efforts to save energy, various technologies have been developed for reducing power consumption of lighting apparatuses installed in buildings, streetlights, houses, and the like.

In order to reduce power consumption of lighting apparatuses, various dimming technologies have been developed for selectively turning on/off the lighting apparatuses or adjusting the illuminance of the lighting apparatuses according to surrounding brightness.

For the dimming control, a dimming signal is input to a lighting apparatus as an analog output, and the lighting apparatus receives the dimming signal and adjusts brightness.

According to the related art, a lighting apparatus and a dimming controller, which outputs a dimming signal according to a user's manipulation, are connected through a cable. Therefore, as the length of the cable increases, a contact resistance also increases. Hence, noise may be generated, and the dimming control desired by the user may not be achieved because the dimming signal is affected by the noise.

In addition, due to the use of the cable, it is inconvenient to install the lighting apparatus and the dimming controller. Moreover, there is a limitation to installation places.

In order to solve these problems, wireless dimming control technologies have been developed and used instead of the existing cable communication scheme.

FIG. 3 is a block diagram illustrating a schematic configuration of a conventional wireless control lighting apparatus.

As illustrated in FIG. 3, the conventional wireless control lighting apparatus 10 may include a power supply unit 20, a wireless communication unit 30, and a light emitting module 60.

The power supply unit 20 receives an AC voltage V_{AC}, converts the AC voltage V_{AC} into a DC voltage suitable for driving the light emitting module 60, and outputs the DC voltage to the wireless communication unit 30. A wireless communication module 40 of the wireless communication unit 30 receives and outputs a dimming signal transmitted from a wireless controller 70, and a dimming control unit 50 of the wireless communication unit 30 processes the applied DC voltage, based on the received dimming signal, and supplies the processed DC voltage to the light emitting module 60. In this manner, the conventional wireless control lighting apparatus 10 performs the dimming control.

The conventional wireless control lighting apparatus 10 using the above-described scheme may solve the problem of the wired communication scheme. However, since the dimming control is performed inside the wireless communication unit 30, the supply of power to the light emitting module 60 is interrupted when a failure occurs in the wireless communication unit 30, or when wireless communication is smoothly performed between the wireless communication unit 30 and the wireless controller 70. Consequently, the lighting apparatus 10 does not operate normally.

### SUMMARY OF THE INVENTION

An aspect of the present invention is directed to provide an optical semiconductor lighting apparatus that is easy to install and construct and can surely maintain airtight seal.

Another aspect of the present invention is to provide an optical semiconductor lighting apparatus that can perform a dimming control to improve installation convenience and stability by using a wireless communication module and a wired standard power supply unit having an embedded dimming control function.

Another aspect of the present invention is directed to provide an optical semiconductor lighting apparatus that can provide stable illumination, regardless of whether a wireless communication unit operates.

According to an embodiment of the present invention, an optical semiconductor lighting apparatus includes: at least one or more clamping units formed is along a longitudinal direction of a race way; a housing in which a power supply unit (PSU) is disposed in an upper portion thereof, and a light emitting module, in which a plurality of semiconductor optical devices are formed in a row, is disposed in a lower portion thereof, the housing being attached to or detached from the clamping unit; a first sealing unit finishing both ends of the housing; and a second sealing unit disposed between the housing and both edges of an optical member, which finishes a bottom surface of the housing, the second sealing unit surrounding upper and lower portions of both edges of the optical member.

The clamping unit may include a clamp that is connected to a bottom surface of the race way and is attached to or detached from both sides of the upper portion of the housing.

The clamping unit may further include: an upper fastener connected to the bottom surface of the race way and penetrating in a vertical direction; and a lower fastener connected to an outer periphery of the upper fastener passing through the clamp.

The clamp may include: a first fastening portion connected to the bottom surface of the race way; and a second fastening portion extending from both edges of the first fastening portion and connected to the housing.

The clamp may further include a clamping hook that extends from an edge of an end of the second fastening portion and corresponds to a shape of a fastening groove formed along a longitudinal direction of the housing on both sides of the upper portion of the housing.

The clamping hook may be inclined upwardly toward a top surface of the housing.

The housing may include: a first body whose both ends are opened, in which a top surface of the first body is connected to the clamping unit, and the PSU is embedded therein; and a second body extending to be inclined from both edges of the bottom surface of the first body and connected to both edges of the optical member. The first sealing unit may finish an area where the housing and the optical member are formed.

The housing may include: a first body whose both ends are opened, in which a top surface of the first body is connected to the clamping unit, and the light emitting module is provided on a bottom surface of the first body; and a second body extending to be inclined from both edges of the bottom surface of the first body and connected to both edges of the optical member. The second sealing unit may be disposed at an edge of an end of the second body and an edge of the optical member.

The first sealing unit may include: an end cap connected to both ends of the housing that is connected to the clamping unit; and a first packing disposed between the end cap and both ends of the housing. The first packing may include at least one or more communication grooves receiving a cable for connecting the power supply unit and the light emitting module. The first packing may be closely contacted with the optical member.

The housing may include: a first body, an upper portion of which is connected to the clamping unit; and a second body extending to be inclined from both edges of a bottom surface of the first body and connected to both edges of the optical member. The end cap may finish an area where the first body, the second body, and the optical member are formed, and the first packing may be disposed along an edge where the second body and the optical member are formed.

The first packing may further include: a removable connection portion extending from an edge of the first packing; and a finish portion having an auxiliary groove having a shape corresponding to the communication groove. The finish portion may be separated from the connection portion to surround the cable.

The second sealing unit may include: a second packing surrounding a latch hook extending to be inclined upwardly from an edge of the optical member; and at least one or more protrusions formed on an outer surface of the second packing, closely contacted with the housing, and elastically deformed.

The housing may include: a second body extending to be inclined from both edges of a bottom surface of a first body, a top surface of which is connected to the clamping unit, and connected to both edges of the optical member; and a close contact groove recessed at an inner end of the second body along a longitudinal direction of the housing. The latch hook and the second packing may be received in the close contact groove.

The housing may further include a latch protrusion extending to be inclined upwardly from an edge of a lower end of the close contact groove. An end of the latch hook may face the latch protrusion. The second packing may be disposed between an upper side of the latch protrusion and an end of the latch hook and may be disposed at the close contact groove.

According to another embodiment of the present invention, an optical semiconductor lighting apparatus includes: a housing in which a power supply unit (PSU) is disposed in an upper portion thereof, and a light emitting module, in which a plurality of semiconductor optical devices are formed in a row, is disposed in a lower portion thereof; a first sealing unit finishing both ends of the housing; and a second sealing unit disposed between the housing and both edges of an optical member, which finishes a bottom surface of the housing, the second sealing unit surrounding upper and lower portions of both edges of the optical member.

The housing may include: a first body whose both ends are opened, in which the PSU is embedded; and a second body extending to be inclined from both edges of the bottom surface of the first body and connected to both edges of the optical member. The first sealing unit may finish an area where the housing and the optical member are formed.

The housing may include: a first body whose both ends are opened, in which the PSU is embedded; and a second body extending to be inclined from both edges of the bottom surface of the first body and connected to both edges of the optical member. The second sealing unit may be disposed at an edge of an end of the second body and an edge of the optical member.

The first sealing unit may include: an end cap connected to both ends of the housing; and a first packing disposed between the end cap and both ends of the housing, the first packing including at least one or more communication grooves receiving a cable for connecting the power supply unit and the light emitting module, the first packing being closely contacted with the optical member.

The housing may include: a first body whose both ends are opened, in which the PSU is embedded; and a second body extending to be inclined from both is edges of a bottom surface of the first body and connected to both edges of the optical member. The end cap may finish an area where the first body, the second body, and the optical member are formed, and the first packing is disposed along an edge where the second body and the optical member are formed.

The first packing may further include: a removable connection portion extending from an edge of the first packing; and a finish portion having an auxiliary groove having a shape corresponding to the communication groove. The finish portion may be separated from the connection portion to surround the cable

The second sealing unit may include: a second packing surrounding a latch hook extending to be inclined upwardly from an edge of the optical member; and at least one or more protrusions formed on an outer surface of the second packing, closely contacted with the housing, and elastically deformed.

The housing may include: a first body whose both ends are opened; a second body extending to be inclined from both edges of a bottom surface of the first body and connected to both edges of the optical member; and a close contact groove recessed at an inner end of the second body along a longitudinal direction of the housing. The latch hook and the second packing may be received in the close contact groove.

The housing may further include a latch protrusion extending to be inclined upwardly from an edge of a lower end of the close contact groove. An end of the latch hook may face the latch protrusion. The second packing may be disposed between an upper side of the latch protrusion and an end of the latch hook and may be disposed at the close contact groove.

The term “semiconductor optical device” used in claims and the detailed description refers to a device that includes or uses an optical semiconductor, such as a light emitting diode (LED) chip or the like.

The semiconductor optical devices may include package level devices with various types of optical semiconductors, including the LED chip.

### BRIEF DESCRIPTION OF THE DRAWINGS

FIG. 1 is an exploded perspective view illustrating an overall configuration of an optical semiconductor lighting apparatus according to an embodiment of the present invention.

FIG. 2 is a block diagram illustrating a configuration of an optical semiconductor lighting apparatus having a wireless control function according to a preferred embodiment of the present invention.

FIG. 3 is a block diagram illustrating a configuration of a conventional wireless control lighting apparatus.

### DETAILED DESCRIPTION OF EXEMPLARY EMBODIMENTS

Exemplary embodiments of the present invention will be described below in detail with reference to the accompanying drawings.

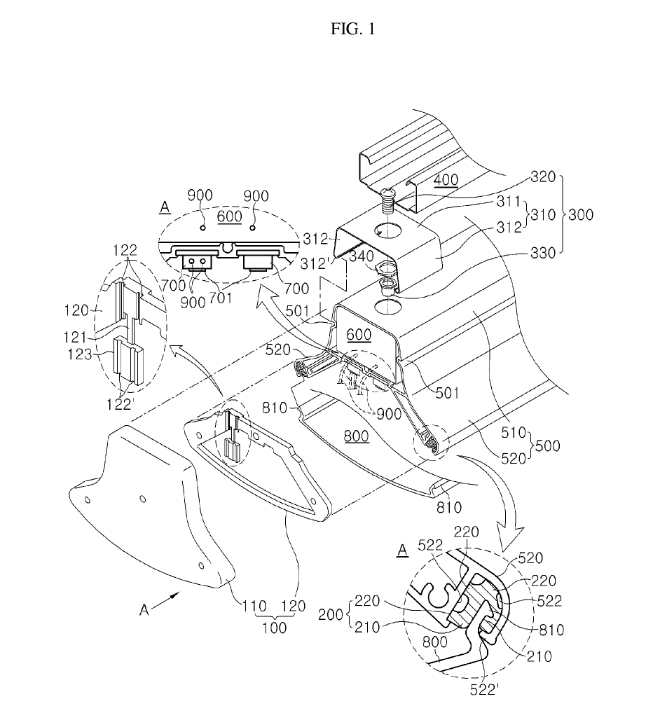

FIG. 1 is an exploded perspective view illustrating an overall configuration of an optical semiconductor lighting apparatus according to an embodiment of the present invention.

As illustrated, the optical semiconductor lighting apparatus according to the embodiment of the present invention is configured such that a housing 500 is is detachably connected to a race way 400, and a first sealing unit 100 and a second sealing unit 200 are provided in the housing 500 to maintain airtight seal.

At least one or more clamping units 300 are formed along a longitudinal direction of the race way 400 in order for connection to the housing 500.

A power supply unit (hereinafter, referred to as a PSU) 600 is disposed in an upper portion of the housing 500. A light emitting module 700, in which a plurality of semiconductor optical devices 701 are formed in a row, is disposed in a lower portion of the housing 500. The housing 500 is attached to or detached from the clamping unit 300.

The first sealing unit 100 finishes both ends of the housing 500 so as to prevent penetration of water or foreign particles.

The second sealing unit 200 is disposed between the housing 500 and both edges of an optical member 800, which finishes the bottom surface of the housing 500. The second sealing unit 200 surrounds the upper and lower portions of both edges of the optical member 800, and prevents penetration of water or foreign particles into the housing, together with the first sealing 100.

It is apparent that the following various embodiments as well as the above-described embodiment can be applied to the present invention.

As described above, the clamping unit 300 is provided for easily connecting the housing 500 to the race way 400. The clamping unit 300 may include a clamp 310 that is connected to the bottom surface of the race way 400 and is attached to or detached from both sides of the upper portion of the housing 500.

Specifically, in the clamping unit 300, an upper fastener 320 connected to the bottom surface of the race way 400 and penetrating in a vertical direction passes is through the clamp 310, and a screw thread formed on the outer periphery of the upper fastener 320 is connected to a lower fastener 330.

A spacer 340 may be further mounted on the top or bottom surface or the clamp 310 so as to maintain spacing.

More specifically, in the clamp 310, a second fastening portion 312 extends from both edges of a first fastening portion 311 connected to the bottom surface of the race way 400. Therefore, the clamp 310 is connected to the housing 500.

Also, the clamp 310 includes a clamping hook 312′ that extends from the edge of the end of the second fastening portion 312 and corresponds to a shape of a fastening groove 501 formed along a longitudinal direction of the housing 500 on both sides of the upper portion of the housing 500.

The clamping hook 312′ may be formed to be inclined upwardly toward the top surface of the housing 500 so as to tightly maintain the connection state between the clamp 310 and the housing 500.

Meanwhile, as described above, the housing 500 provides a space for mounting the first and second sealing units 100 and 200, and largely includes a first body 510 and a second body 520.

That is, the first body 510 is a member whose both ends are opened. The top surface of the first body 510 is connected to the clamping unit 300. The PSU 600 is embedded in the first body 510. The light emitting module 700 is provided on the bottom surface of the first body 510. The second body 520 extends to be inclined from both edges of the bottom surface of the first body 510, and is connected to both edges of the optical member 800. The second body 520 serves as a reflector.

Although it is illustrated in FIG. 1 that the pair of the light emitting modules 700 are disposed in parallel to the bottom surface of the PSU 600, that is, in the ‘-’ shape on a straight line, the present invention is not limited thereto. The bottom surface of the first body 510 is formed in a V shape according to the structural characteristic of the second body 520 extending to be inclined from both edges of the first body 510. In this manner, modifications and applications can also be made to vary the illumination range of light.

The first sealing unit 100 finishes the area where the housing 500 and the optical member 800 are formed, and the second sealing unit 200 is disposed at the edge of the end of the second body 520 and the edge of the optical member 800.

In this case, the first sealing unit 100 includes an end cap 110 connected to both ends of the housing 500, and a first packing 120 disposed between both ends of the housing 500.

The end cap 110 finishes the area where the first body 510, the second body 520, and the optical member 800 are formed.

The first packing 120 includes at least one or more communication grooves 122, which receive a cable 900 connecting the PSU 600 to the light emitting module 700, and is closely contacted with the optical member 800.

That is, the first packing 120 is disposed along the edge where the second body 520 and the optical member 800 are formed.

In addition, the first packing 120 may include a finish portion 123 at an end of a removable connection portion 121 extending from one edge of the first packing 120.

The finish portion 123 includes an auxiliary groove 122′ having a shape corresponding to the communication groove 122. When the connection portion 121 is removed, the finish portion 123 is separated from the first packing 122 to surround the cable 900.

FIG. 1 illustrates the state in which the connection portion 121 and the finish portion 123 are connected to the first packing 120. However, when the first sealing unit 100 is actually connected to the housing 500, the end cap 110 is connected to the housing 500 by removing the connection portion 121 and then bringing the finish portion 123 into close contact with the first packing 120.

Meanwhile, the second sealing unit 200 includes a second packing 210 surrounding a latch hook 810 extending to be inclined upwardly from the edge of the optical member 800.

The second packing 210 may include at least one or more protrusions 220 that are formed on the outer surface thereof, are closely contacted with the housing 500, and are elastically deformed.

The protrusion 220 facilitates the connection to the optical member 800, maintains airtight seal between the optical member 800 and the second body 520, and prevents shock or vibration from being directly transferred between the housing 500 and the optical member 800.

For connection of the optical member 800 and the second sealing unit 200, it is preferable that a close contact groove 522 is recessed at the inner end of the second body 520 along a longitudinal direction of the housing 500, and the latch hook 810 and the second packing 210 are received in the close contact groove 522.

The second body 520 may further include a latch protrusion 522′ extending to be inclined upwardly from the edge of the lower end of the close contact groove 522 so as to prevent the second packing 210 from being released.

In this case, the end of the latch hook 810 faces the latch protrusion 522′, and the second packing 210 is disposed between the upper side of the latch protrusion 522′ and the end of the latch hook 810 and is disposed at the close contact groove 522. Therefore, the second sealing unit 200 surrounds the upper and lower sides of the edge of the optical member 810, thereby further improving airtight seal.

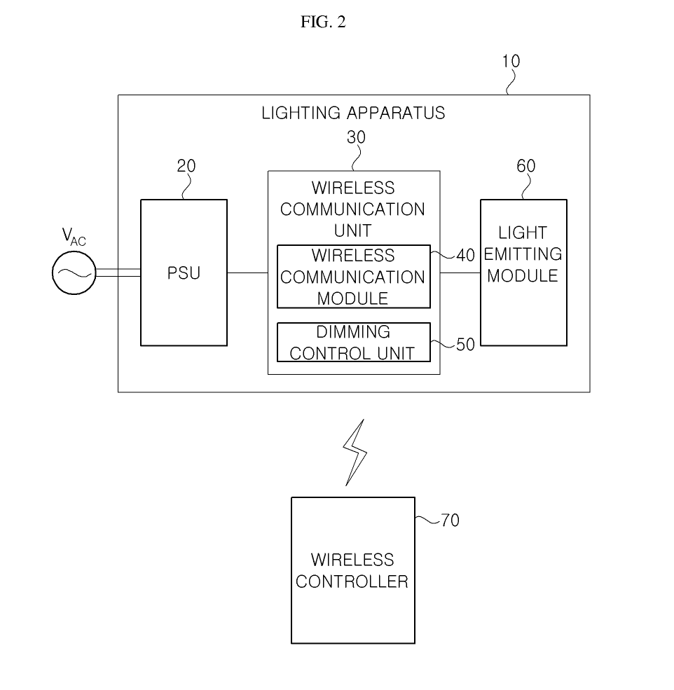

FIG. 2 is a block diagram illustrating a configuration of an optical semiconductor lighting apparatus having a wireless control function according to a preferred embodiment of the present invention.

Hereinafter, the configuration and function of the optical semiconductor lighting apparatus according to the preferred embodiment of the present invention will be described with reference to the accompanying drawings.

As illustrated in FIG. 2, the optical semiconductor lighting apparatus having the wireless control function according to the present invention may include a PSU 600, a wireless communication unit 640, and a light emitting module 700.

First, the wireless communication unit 640 according to the present invention is configured to perform wireless data communication between a wireless controller 650 and/or a wireless sensor 660 through a wireless communication network.

The wireless communication unit 640 may be configured to perform the wireless data communication by using one of various known near field communication schemes, such as infrared communication, Bluetooth communication, ZigBee communication, and wireless LAN communication schemes.

The wireless communication unit 640 receives a dimming signal transmitted from the wireless controller 650 and/or illuminance information of an illumination target area transmitted from the wireless sensor 660 according to the user's manipulation, and outputs the received dimming signal and/or illuminance information to the PSU 600.

Although FIG. 2 illustrates the embodiment in which the wireless communication unit 640 according to the present invention is provided inside the optical semiconductor lighting apparatus 1000, the present invention is not limited thereto. If necessary, the wireless communication unit 640 according to the present invention may be provided outside the optical semiconductor lighting apparatus 1000.

In the case where the wireless communication unit 640 is provided outside the optical semiconductor lighting apparatus 1000, the wireless communication unit 640 and the optical semiconductor lighting apparatus 1000 are connected through a cable. It is preferable that the wireless communication unit 640 and the optical semiconductor lighting apparatus 1000 are configured to maintain airtight seal so as to prevent penetration of water or foreign particles.

The light emitting module 700 includes a plurality of semiconductor optical devices 701, such as light emitting cells, LED elements, LED packages, LED chips, and LED arrays. The light emitting module 700 receives DC power from the PSU 600 and emits light.

It is apparent that the type, number, and arrangement of the semiconductor optical devices 701 constituting the light emitting module 700 can be variously changed when necessary. However, for convenience of description and understanding, the following description will focus on the light emitting module 700 configured using LED elements.

Meanwhile, the PSU 600 according to the present invention is configured to perform two functions.

First, the PSU 600 is connected to an external AC power source (for example, 220V AC power source) and receives an AC voltage V_{AC}. Also, the PSU 600 converts the received AC voltage V_{AC} into a DC voltage suitable for driving the light emitting module 700, and supplies the DC voltage to the light emitting module 700.

Also, the PSU 600 according to the present invention is configured to perform a dimming control function of receiving a dimming signal and/or illuminance information from the wireless communication unit 640, and controlling the illuminance of the light emitting module 700, based on the received dimming signal and/or illuminance information.

In order to perform the above-described functions, the PSU 600 according to the present invention may include a rectification unit 610, a control current control unit 630, and a dimming control unit 620.

The rectification unit 610 performs a function of full-wave-rectifying the received AC voltage into the DC voltage.

The rectification unit 610 may use a bridge diode type rectification circuit configured using a widely-used bridge diode, but the present invention is not limited thereto. Various types of full-wave rectification circuits can also be applied to the rectification unit 610 according to the present invention.

Also, a noise filter (not illustrated) for removing noise from the AC voltage and a fuse circuit for preventing inflow of overcurrent may be further included at a front end of the rectification unit 610. Also, a stabilization circuit (not illustrated) (for example, a smoothing capacitor) for removing AC component and a power factor compensation circuit (not illustrated) may be further included at a rear end of the rectification unit 610.

Since the configuration and function of the rectification unit 610 employ known technologies, a detailed description thereof will be omitted.

The constant current control unit 630 performs a control function of sensing a current flowing through the light emitting module 700 and maintaining the current flowing through the light emitting module 700 at a set constant current value.

The dimming control unit 620 is configured to control the illuminance of the light emitting module 700 according to the dimming signal and/or the illuminance information input from the wireless communication unit 640.

Generally, the dimming control for the light emitting module 700 configured with a plurality of LEDs may be performed using one of two methods.

The dimming control unit 620 according to the present invention may be configured to perform the dimming control according to one of two methods described below.

1. Dimming Control Unit According to First Embodiment (Analog Dimming Control)

The dimming control unit 620 according to the first embodiment of the present invention is configured to perform the dimming control by controlling the magnitude of the forward current flowing through the light emitting module 700, that is, the current value, in an analog manner.

When the dimming signal is input from the wireless communication unit 640, the dimming control unit 620 determines a level of a current sensed through the constant current control unit 630, and controls the constant current control unit 630 to increase or decrease the current flowing through the light emitting module 700 according to the dimming level of the input dimming signal.

In a similar manner, when the illuminance information is input from the wireless communication unit 640, the dimming control unit 620 calculates the dimming level, based on the current illuminance information according to dimming control setting information and a preset algorithm, and performs the dimming control by controlling the constant current control unit 630 to increase or decrease the current flowing through the light emitting module 700, based on the calculated dimming level.

Meanwhile, according to other configurations, the dimming control may be performed by directly increasing or decreasing the magnitude of the DC voltage applied to the light emitting module 700, without directly controlling the current flowing through the light emitting module 700.

2. Dimming Control Unit According to Second Embodiment (Pulse Width Modulation (PWM) Dimming Control)

The dimming control unit 620 according to the second embodiment of the present invention is configured to control the illuminance of the light emitting module 700 by using a PWM scheme.

The PWM dimming control refers to a dimming control scheme that is controls the illuminance of the light emitting module 700 by turning on/off the DC voltage supplied to the light emitting module 700 according to a PWM signal.

Therefore, when the dimming signal and/or the illuminance information are/is input from the wireless communication unit 640, the dimming control unit 620 according to the second embodiment of the present invention performs the dimming control by adjusting a duty ratio of the PWM signal, based on the input dimming signal and/or illuminance information.

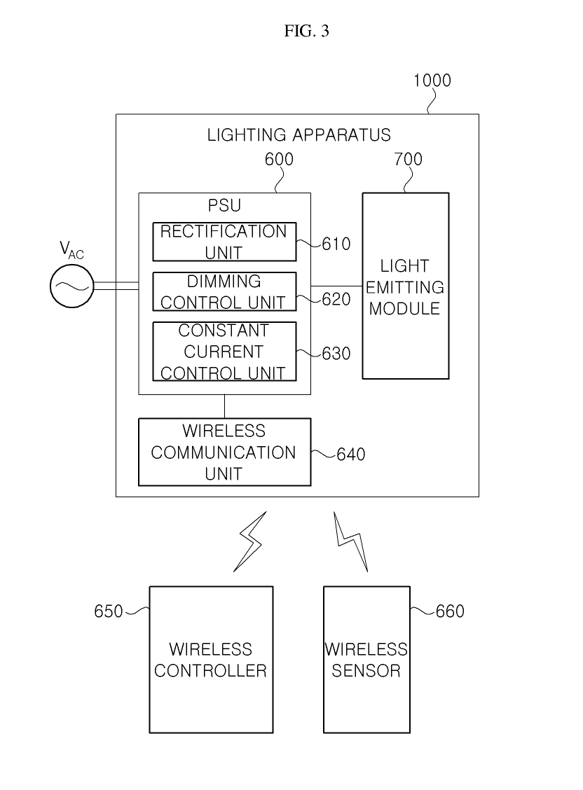

Also, as opposed to the conventional wireless control light apparatus described above with reference to FIG. 3, the PSU 600 according to the present invention is configured to perform the normal operation, that is, to continuously supply the DC voltage to the light emitting module 700, regardless of whether or not the wireless communication unit 640 operates.

In order to perform this function, the PSU 600 according to the present invention is configured to supply the DC voltage to the light emitting module 700 according to a preset reference value, and perform the dimming control only when the dimming signal and/or the illuminance information are/is input from the wireless communication unit 640.

Also, after the dimming signal and/or the illuminance information are/is input and thus the dimming control is performed based on the dimming signal and/or the illuminance information, the operation of the light emitting module 700 may be controlled according to the dimming level based on the previous dimming signal and/or illuminance information, until other dimming signal and/or illuminance information are/is newly input.

According to other configurations, the PSU 600 according to the present invention is configured to monitor the state of the wireless communication unit 640, and control the operation of the light emitting module 700 according to the preset reference value when it is determined that a failure occurs in the wireless communication unit 640.

For example, when the preset reference value is set to 80% of the maximum dimming level, the PSU 600 performs the dimming control such that the dimming level of the light emitting module 700 becomes 80%, when it is determined that a failure occurs in the wireless communication unit 640, or when it is determined that a failure occurs in the wireless communication.

It is apparent to those skilled in the art that the reference value can be set variously if necessary. Also, various known technologies can be used for determining whether a failure occurs in the wireless communication unit 640.

On the other hand, the PSU 600 according to the present invention may be implemented using a wired standard PSU with an embedded dimming control function.

The most significant technical characteristic of the optical semiconductor lighting apparatus according to the present invention is that the optical semiconductor lighting apparatus having the wireless control function can be configured simply and easily by using the wired standard PSU having the dimming control function and the wireless communication unit capable of receiving the dimming signal, and the illumination can be continuously provided even when a failure occurs in the wireless communication unit 640, or even when a failure occurs in the wireless communication.

Meanwhile, the wireless controller 650 and the wireless sensor 660, is which are illustrated in FIG. 2 together with the optical semiconductor lighting apparatus 1000, are configured to perform wireless data communication with the wireless communication unit 640 of the optical semiconductor lighting apparatus 1000.

The wireless controller 650 is configured to transmit the input dimming signal to the optical semiconductor lighting apparatus 1000 according to the manipulation of the user or manager.

The wireless sensor 660 is installed in a predetermined area where dimming is performed by the optical semiconductor lighting apparatus 1000, and is configured to sense the current illuminance of the dimming area and transmit the sensed illuminance information to the optical semiconductor lighting apparatus 1000.

As described above, the basic technical spirit of the present invention is to provide the optical semiconductor lighting apparatus is easy to install and construct, can surely maintain airtight seal, can perform the dimming control to improve the installation convenience and stability by using the wireless communication module and the wired standard PSU having the embedded dimming control function, and can provide stable illumination, regardless of whether the wireless communication unit operates.

It is apparent to those skilled in the art that various modifications and applications can also be made without departing from the basic technical spirit and scope of the present invention. For example, the clamping unit 300 may be omitted, and the housing 500 may be directly fixed to the race way 400 through a fastener such as a bolt. Although not specifically illustrated, a pendent type lighting apparatus can be implemented by connecting the race way 400 and the housing 500 through various members, such as wires or chains, instead of the clamping unit 300.

According to the present invention, since the housing is detachably connected to the race way by the clamping unit, installation and construction are easily achieved.

Due to the structure in which the housing is directly connected to the race way, the connection state can be securely maintained even when an earthquake occurs. Also, since the housing is easily separated from the clamping unit, the replacement, repair, and inspection can be efficiently performed.

Since the first sealing unit is provided at both ends of the housing and the second sealing unit is provided between the housing and the optical member, the airtight seal can be maintained to prevent penetration of water or foreign particles.

Therefore, the first and second sealing units can prevent a short circuit and an erroneous operation. Moreover, the first and second sealing units can prevent discoloration and corrosion, thereby extending durability and lifespan.

Furthermore, the present invention can expect that the installation/control convenience and stability of the optical semiconductor lighting apparatus can be improved by using the wireless communication module and the wired standard power supply unit having the embedded dimming control function.

Moreover, the present invention can expect that the stable illumination can be provided, regardless of whether the wireless communication unit receiving the dimming signal through the wireless communication network operates.

While the embodiments of the present invention have been described with reference to the specific embodiments, it will be apparent to those skilled in the art is that various changes and modifications may be made without departing from the spirit and scope of the invention as defined in the following claims.

What is claimed is:

1. An optical semiconductor lighting apparatus comprising:
at least one or more clamping units formed along a longitudinal direction of a race way;
a housing in which a power supply unit (PSU) is disposed in an upper portion thereof, and a light emitting module, in which a plurality of semiconductor optical devices are formed in a row, is disposed in a lower portion thereof, the housing being attached to or detached from the clamping unit;
a first sealing unit finishing both ends of the housing; and
a second sealing unit disposed between the housing and both edges of an optical member, which finishes a bottom surface of the housing, the second sealing unit surrounding upper and lower portions of both edges of the optical member.

2. The optical semiconductor lighting apparatus of claim 1, wherein the clamping unit comprises a clamp that is connected to a bottom surface of the race way and is attached to or detached from both sides of the upper portion of the housing.

3. The optical semiconductor lighting apparatus of claim 2, wherein the clamping unit further comprises:
an upper fastener connected to the bottom surface of the race way and penetrating in a vertical direction; and
a lower fastener connected to an outer periphery of the upper fastener passing through the clamp.

4. The optical semiconductor lighting apparatus of claim 2, wherein the clamp comprises:
a first fastening portion connected to the bottom surface of the race way; and
a second fastening portion extending from both edges of the first fastening portion and connected to the housing.

5. The optical semiconductor lighting apparatus of claim 4, wherein the clamp further comprises a clamping hook that extends from an edge of an end of the second fastening portion and corresponds to a shape of a fastening groove formed along a longitudinal direction of the housing on both sides of the upper portion of the housing.

6. The optical semiconductor lighting apparatus of claim 5, wherein the clamping hook is inclined upwardly toward a top surface of the housing.

7. The optical semiconductor lighting apparatus of claim 1, wherein the housing comprises:
a first body whose both ends are opened, in which a top surface of the first body is connected to the clamping unit, and the PSU is embedded therein; and
a second body extending to be inclined from both edges of the bottom surface of the first body and connected to both edges of the optical member,
wherein the first sealing unit finishes an area where the housing and the optical member are formed.

8. The optical semiconductor lighting apparatus of claim 1, wherein the housing comprises:
a first body whose both ends are opened, in which a top surface of the first body is connected to the clamping unit, and the light emitting module is provided on a bottom surface of the first body; and
a second body extending to be inclined from both edges of the bottom surface of the first body and connected to both edges of the optical member,
wherein the second sealing unit is disposed at an edge of an end of the second body and an edge of the optical member.

9. The optical semiconductor lighting apparatus of claim 1, wherein the first sealing unit comprises:
an end cap connected to both ends of the housing that is connected to the clamping unit; and
a first packing disposed between the end cap and both ends of the housing, the first packing including at least one or more communication grooves receiving a cable for connecting the power supply unit and the light emitting module, the first packing being closely contacted with the optical member.

10. The optical semiconductor lighting apparatus of claim 9, wherein the housing comprises:
a first body, an upper portion of which is connected to the clamping unit; and
a second body extending to be inclined from both edges of a bottom surface of the first body and connected to both edges of the optical member,
wherein the end cap finishes an area where the first body, the second body, and the optical member are formed, and the first packing is disposed along an edge where the second body and the optical member are formed.

11. The optical semiconductor lighting apparatus of claim 9, wherein the first packing further comprises:
a removable connection portion extending from an edge of the first packing; and
a finish portion having an auxiliary groove having a shape corresponding to the communication groove, the finish portion being separated from the connection portion to surround the cable.

12. The optical semiconductor lighting apparatus of claim 1, wherein the second sealing unit comprises:
a second packing surrounding a latch hook extending to be inclined upwardly from an edge of the optical member; and
at least one or more protrusions formed on an outer surface of the second packing, closely contacted with the housing, and elastically deformed.

13. The optical semiconductor lighting apparatus of claim 12, wherein the housing comprises:
a second body extending to be inclined from both edges of a bottom surface of a first body, a top surface of which is connected to the clamping unit, and connected to both edges of the optical member; and
a close contact groove recessed at an inner end of the second body along a longitudinal direction of the housing,
wherein the latch hook and the second packing are received in the close contact groove.

14. The optical semiconductor lighting apparatus of claim 13, wherein:
the housing further comprises a latch protrusion extending to be inclined upwardly from an edge of a lower end of the close contact groove;
an end of the latch hook faces the latch protrusion; and
the second packing is disposed between an upper side of the latch protrusion and an end of the latch hook and is disposed at the close contact groove.

15. An optical semiconductor lighting apparatus comprising:
a housing in which a power supply unit (PSU) is disposed in an upper portion thereof, and a light emitting module, in which a plurality of semiconductor optical devices are formed in a row, is disposed in a lower portion thereof;
a first sealing unit finishing both ends of the housing; and
a second sealing unit disposed between the housing and both edges of an optical member, which finishes a bottom surface of the housing, the second sealing unit surrounding upper and lower portions of both edges of the optical member.

16. The optical semiconductor lighting apparatus of claim 15, wherein the housing comprises:
a first body whose both ends are opened, in which the PSU is embedded; and
a second body extending to be inclined from both edges of the bottom surface of the first body and connected to both edges of the optical member,
wherein the first sealing unit finishes an area where the housing and the optical member are formed.

17. The optical semiconductor lighting apparatus of claim 15, wherein the housing comprises:
a first body whose both ends are opened, in which the PSU is embedded; and
a second body extending to be inclined from both edges of the bottom surface of the first body and connected to both edges of the optical member,
wherein the second sealing unit is disposed at an edge of an end of the second body and an edge of the optical member.

18. The optical semiconductor lighting apparatus of claim 15, wherein the first sealing unit comprises:
an end cap connected to both ends of the housing; and
a first packing disposed between the end cap and both ends of the housing, the first packing including at least one or more communication grooves receiving a cable for connecting the power supply unit and the light emitting module, the first packing being closely contacted with the optical member.

19. The optical semiconductor lighting apparatus of claim 18, wherein the housing comprises:
a first body whose both ends are opened, in which the PSU is embedded; and
a second body extending to be inclined from both edges of a bottom surface of the first body and connected to both edges of the optical member,
wherein the end cap finishes an area where the first body, the second body, and the optical member are formed, and the first packing is disposed along an edge where the second body and the optical member are formed.

20. The optical semiconductor lighting apparatus of claim 18, wherein the first packing further comprises:
a removable connection portion extending from an edge of the first packing; and
a finish portion having an auxiliary groove having a shape corresponding to the communication groove, the finish portion being separated from the connection portion to surround the cable.

21. The optical semiconductor lighting apparatus of claim 15, wherein the second sealing unit comprises:
a second packing surrounding a latch hook extending to be inclined upwardly from an edge of the optical member; and
at least one or more protrusions formed on an outer surface of the second packing, closely contacted with the housing, and elastically deformed.

22. The optical semiconductor lighting apparatus of claim 21, wherein the housing comprises:
a first body whose both ends are opened;
a second body extending to be inclined from both edges of a bottom surface of the first body and connected to both edges of the optical member; and
a close contact groove recessed at an inner end of the second body along a longitudinal direction of the housing,
wherein the latch hook and the second packing are received in the close contact groove.

23. The optical semiconductor lighting apparatus of claim 22, wherein:
the housing further comprises a latch protrusion extending to be inclined upwardly from an edge of a lower end of the close contact groove;
an end of the latch hook faces the latch protrusion; and
the second packing is disposed between an upper side of the latch protrusion and an end of the latch hook and is disposed at the close contact groove.
